(19) United States
(12) Patent Application Publication
(10) Pub. No.: US 2018/0192067 A1
(43) Pub. Date: Jul. 5, 2018

(54) SCHEDULING METHOD FOR HIGH EFFICIENCY VIDEO CODING APPARATUS

(71) Applicant: MStar Semiconductor, Inc., Hsinchu Hsien (TW)

(72) Inventors: Cheng-Yu Hsieh, Hsinchu Hsien (TW); Yu-Hsiang Tseng, Hsinchu Hsien (TW)

(21) Appl. No.: 15/850,482

(22) Filed: Dec. 21, 2017

(30) Foreign Application Priority Data
Jan. 4, 2017 (TW) 106100100

(51) Int. Cl. H04N 19/43; H04N 19/107; H04N 19/186; H04N 19/593; H04N 19/625; H04N 19/124; H04N 19/51; H04N 19/136

(52) U.S. Cl. CPC H04N 19/43; H04N 19/107; H04N 19/186; H04N 19/136; H04N 19/625; H04N 19/124; H04N 19/51; H04N 19/593

(57) ABSTRACT

A scheduling method for a high efficiency video coding (HEVC) apparatus is provided. A plurality of input frame signals are received by a scheduling module of the HEVC apparatus to generate a control signal to determine whether an inter/intra-frame coding operation is to be performed on each of the input frame signals. When the control signal is determined to perform the inter/intra-frame coding operation, the HEVC apparatus performs a first coding operation and a second coding operation sequentially on multiple of the plurality of frame signals in each working cycle. Each working cycle is a time period corresponding to one of the first coding operation and the second coding operation that a single luma frame signal or a single chroma frame signal undergoes.

This application claims the benefit of Taiwan application Serial No. 106100100, filed Jan. 4, 2017, the subject matter of which is incorporated herein by reference.

### BACKGROUND OF THE INVENTION

### Field of the Invention

The invention relates in general to a scheduling method for a high efficiency video coding (HEVC) apparatus, and more particularly to a scheduling method capable of adaptively adjusting a scheduling sequence of a coding operation performed on input frame signals to enhance processing efficiency of the HEVC apparatus.

### Description of the Related Art

Conventionally, a high efficiency video coding (HEVC) apparatus receives audio/video data including a plurality of input frame signals. Each of the input frame signals includes a plurality of luma frame signals and a plurality of chroma frame signals, and each luma frame signal and each chroma frame signal correspond to a matrix signal. As such, each luma frame signal and each chroma frame signal respectively include a plurality of numbered sub-luma frame signals and a plurality of numbered sub-chroma frame signals. Dependency exists among the sub-luma frame signals or the sub-chroma frame signals, i.e., a next numbered sub-luma frame signal or a next numbered sub-chroma frame signal needs to refer to a coding result of a previous numbered sub-luma frame signal or a previous numbered sub-chroma frame signal. When performing an intra-frame coding operation, the HEVC apparatus needs to perform corresponding operations (e.g., a pixel estimation operation, a discrete cosine transform operation, a quantization operation, an inverse quantization operation, an inverse discrete cosine transform operation, and a pixel reconstruction operation) sequentially on the sub-luma frame signals or sub-chroma frame signals, which causes most hardware resources to remain in a state of awaiting for input signals. In other words, the scheduling of the hardware cannot be effectively exercised. Further, when an HEVC apparatus is to perform an inter/intra-frame coding operation, it is necessary that the current HEVC apparatus perform the coding operation sequentially on a plurality of input frame signals one after another, which similarly leads to inefficient scheduling of hardware resources.

Therefore, there is a need for a scheduling method for an HEVC apparatus to enhance the processing efficiency of intra-frame coding operations as well as inter/intra-frame coding operations of the HEVC apparatus.

### SUMMARY OF THE INVENTION

The invention is directed to a scheduling method capable of adaptively adjusting the scheduling sequence of a coding operation of input frame signals to correspondingly enhance the processing efficiency of a high efficiency video coding (HEVC) apparatus.

The present invention discloses a scheduling method for an HEVC apparatus. In the scheduling method, a scheduling module of the HEVC apparatus receives a plurality of input frame signals to generate a control signal to determine whether each of the input frame signal is to undergo an inter/intra-frame coding operation, and determines whether each of input signals is a luma frame signal or a chroma frame signal. When the control signal is determined to perform the inter/intra-frame coding operation, the HEVC apparatus performs one of a first coding operation and a second operation sequentially on multiple of the plurality of frame signals in each working cycle. The first coding operation is sequentially performing a pixel estimation operation, a discrete cosine transform operation, a quantization operation, an inverse quantization operation, an inverse discrete cosine transform operation and a pixel reconstruction operation. The second coding operation is sequentially performing a motion compensation operation, the discrete cosine transform operation, the quantization operation, the inverse quantization operation, the inverse discrete cosine transform operation and the pixel reconstruction operation. Each of the working cycles is a time period corresponding to one of the first coding operation and the second coding operation that a single luma frame signal or a single chroma signal in each input frame signal undergoes.

The present invention further discloses an HEVC apparatus including a scheduling module and a work loop module. The scheduling module receives a plurality of input frame signals to generate a control signal to determine whether each of the input frame signals is to undergo an inter/intra-frame coding operation, and determines whether each of the input frame signals is a luma frame signal or a chroma frame signal. The work loop module, coupled to the scheduling module, includes an estimation module, a discrete cosine transform module, a quantization module, an inverse quantization module, an inverse discrete cosine transform module and a pixel reconstruction module that are sequentially coupled. When the control signal is determined to perform the inter/intra-frame coding operation, the work loop module performs a first coding operation and a second coding operation sequentially on multiple of the plurality of input frame signals in each work cycle. The first coding operation is sequentially performing a pixel estimation operation, a discrete cosine transform operation, a quantization operation, an inverse quantization operation, an inverse discrete cosine transform operation and a pixel reconstruction operation. The second coding operation is sequentially performing a motion compensation operation, the discrete cosine transform operation, the quantization operation, the inverse quantization operation, the inverse discrete cosine transform operation and the pixel reconstruction operation. Each of the working cycles is a time period corresponding to one of the first coding operation and the second coding operation that a single luma frame signal or a single chroma signal in each input frame signal undergoes.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a high efficiency video coding (HEVC) apparatus according to an embodiment of the present invention;

FIG. 2 is a flowchart of a scheduling process according to an embodiment of the present invention;

FIG. 3 is a flowchart of an intra-frame coding process according to an embodiment of the present invention;

FIG. 4 is a schematic diagram of a luma frame signal and a plurality of chroma frame signals according to an embodiment of the present invention;

FIG. 5 is a schematic diagram of timings of performing intra-frame coding operation corresponding to the luma frame signal and the plurality of chroma frame signals in the embodiment in FIG. 4;

FIG. 6 is a flowchart of an inter/intra-frame coding process according to an embodiment of the present invention;

FIG. 7 is a schematic diagram of timings of performing an inter/intra-frame coding operation corresponding to luma frame signals of a plurality of input frame signals according to an embodiment of the present invention; and

FIG. 8 is a schematic diagram of a scheduling module in FIG. 1 according to an embodiment of the present invention.

### DETAILED DESCRIPTION OF THE INVENTION

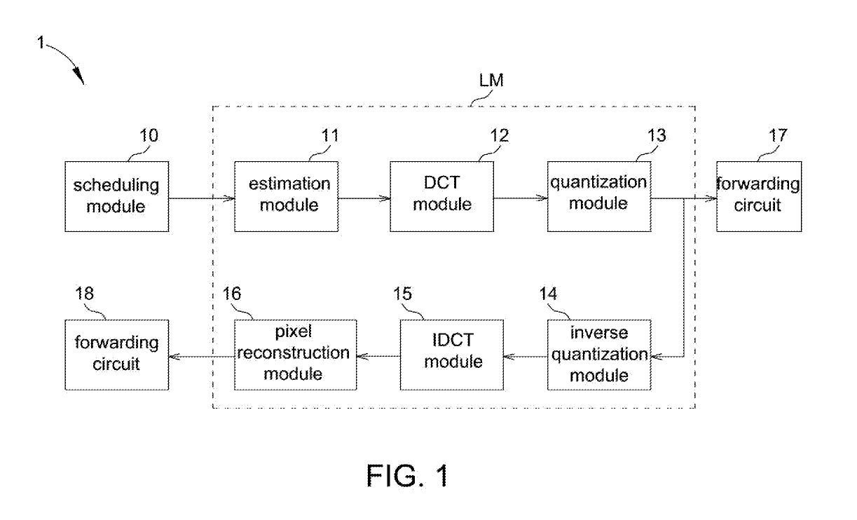

FIG. 1 shows a schematic diagram of a high efficiency video coding (HEVC) apparatus 1 according to an embodiment of the present invention. As shown in FIG. 1, the HEVC apparatus 1 includes a scheduling module 10 and a work loop module LM. The scheduling module 10 receives a plurality of input frame signals to generate a control signal to determine whether each of the input frame signals is to undergo an intra-frame coding operation or an inter/intra-frame coding operation, and determines whether each of the input frame signals is a luma frame signal or a chroma frame signal. The work loop module LM, coupled to the scheduling module 10, includes an estimation module 11, a discrete cosine transform (DCT) module 12, a quantization module 13, an inverse quantization module 14, an inverse discrete cosine transform (IDCT) module 15 and a pixel reconstruction module 16, which are sequentially coupled and correspondingly perform a pixel estimation operation or a motion compensation operation, a discrete cosine transform operation, a quantization operation, an inverse quantization operation, an inverse discrete cosine transform operation and a pixel reconstruction operation. Details of these operations are generally known to one person skilled in the art, and shall be omitted for brevity.

The quantization module 13 is further coupled to a forwarding circuit 17, which receives and outputs a residual signal generated by the quantization module 13 to an intra-frame luma buffer or an intra-frame chroma buffer (not shown). The pixel reconstruction 16 is further coupled to another forwarding circuit 18, which receives and outputs a reconstruction signal outputted by the pixel reconstruction module 16 to another intra-frame luma buffer or another intra-frame chroma buffer (not shown), to allow associated signals buffered in the intra-frame luma buffer or the intra-frame chroma buffer to serve for operations of the HEVC apparatus 1. For example, the intra-frame luma buffer that receives the residual signal and the another intra-frame luma buffer that receives the reconstruction signal may be individual and independent buffers, or different buffer blocks of the same memory. The same applies to the intra-frame chroma buffers. Further, each of the estimation module 11, the discrete cosine transform module 12, the quantization module 13, the inverse quantization module 14, the inverse discrete cosine quantization module 15 and the pixel reconstruction module 16 includes a parser, which receives the control signal generated by the scheduling module 10 to correspondingly determine whether the currently received at least one input frame signal is to undergo the intra-frame coding operation or the inter/intra-frame coding operation, and further determines whether the input frame signal is a luma frame signal or the chroma frame signal at the same time.

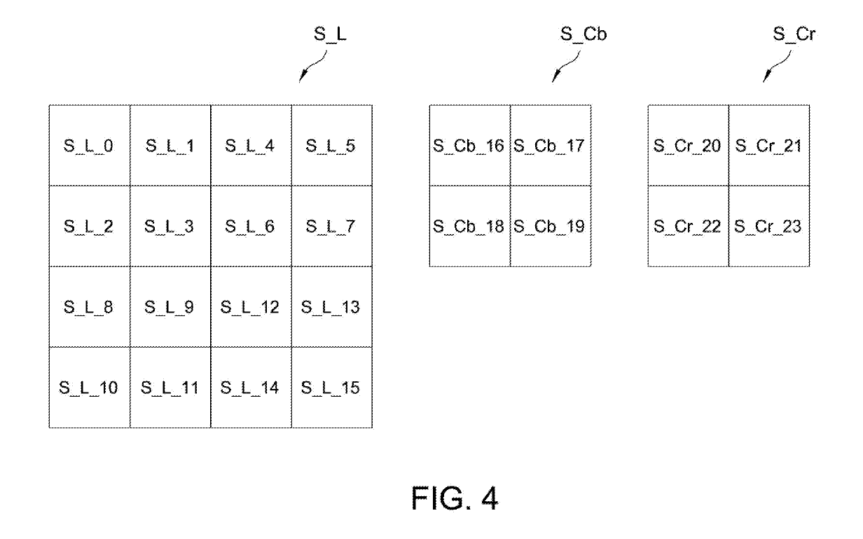

It should be noted that, in this embodiment, each of the input frame signals includes a plurality of luma frame signals and a plurality of chroma frame signals. Each of the luma frame signals and the chroma frame signals corresponds a matrix signal, each of the luma frame signals includes a plurality of numbered sub-luma frame signals, and each of the chroma frame signals includes a plurality of numbered sub-chroma frame signals. The numbering method may be a Z-type coding (as shown in FIG. 4), for example. In this case, the HEVC apparatus 1 of this embodiment first determines whether the received input frame signal is to undergo an intra-frame coding operation or an inter/intra-frame coding operation by the scheduling module 10, at the same time determines whether the input frame signal is a luma frame signal or a chroma frame signal, and outputs the determination result as a control signal that is then transmitted to the work loop module LM. Accordingly, a first coding operation and a second coding operation are performed on the sub-luma frame signals and the sub-chroma frame signals. The first coding operation is sequentially performing a pixel estimation operation, a discrete cosine transform operation, a quantization operation, an inverse quantization operation, an inverse discrete cosine transform operation and a pixel reconstruction operation. The second coding operation is sequentially performing a motion compensation operation, the discrete cosine transform operation, the quantization operation, the inverse quantization operation, the inverse discrete cosine transform operation and the pixel reconstruction operation. Associated details are to be given shortly.

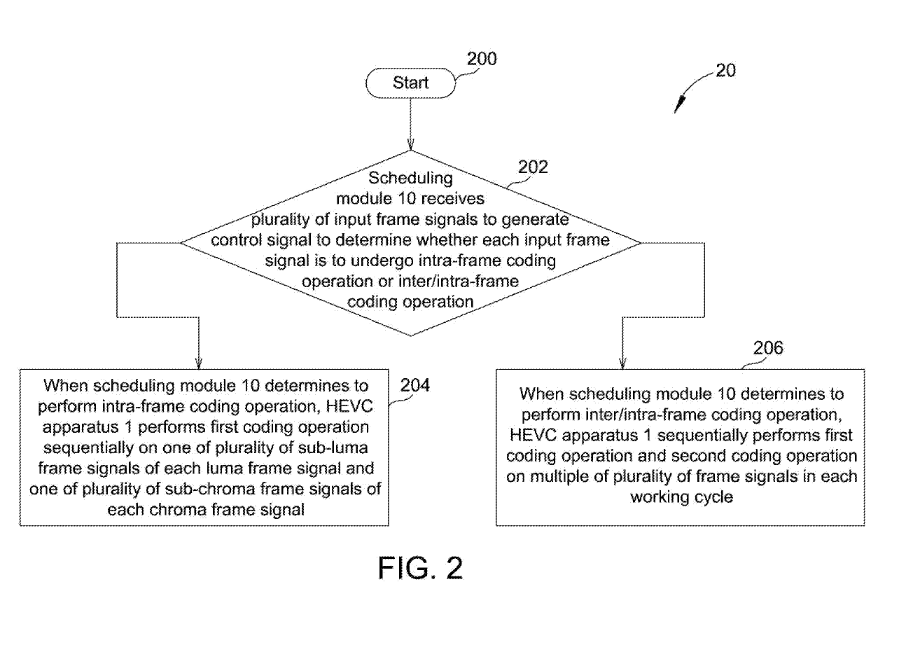

Further, the scheduling method applied to the HEVC apparatus 1 may be concluded to a scheduling process 20, compiled as a program code that is stored in a storage device of the HEVC apparatus 1, and performed by a processor module of the HEVC apparatus 1 to control associated operations of the scheduling module 10 and the work loop module LM. As shown in FIG. 2, the scheduling process 20 includes following steps.

In step 200, the scheduling process 20 begins.

In step 202, the scheduling module 10 receives a plurality of input frame signal to generate a control signal to determine whether each of the input frame signals is to undergo an intra-frame coding operation or an inter/intra-frame coding operation. Step 204 is performed when it is determined that each input frame signal is to undergo the intra-frame coding operation, otherwise step 206 is performed when it is determined that each input frame signal is to undergo the inter/intra-frame coding operation.

In step 204, when the scheduling module 10 determines that each input frame signal is to undergo the intra-frame coding operation, the HEVC apparatus 1 performs a first coding operation sequentially on one of a plurality of sub-luma frame signals of each luma frame signal and one of a plurality of sub-chroma frame signals of each chroma frame signal.

In step 206, when the scheduling module 10 determines that each input frame signal is to undergo the inter/intra-frame coding operation, the HEVC apparatus 1 performs the first coding operation and the second coding operation sequentially on multiple of the plurality of input frame signals in each working cycle.

The program code corresponding to the scheduling process 20 of the embodiment may be correspondingly stored in the scheduling module 10, the estimation module 11, a discrete cosine transform module 12, the quantization module 13, the inverse quantization module 14, the inverse discrete cosine transform module 16 and the pixel reconstruction module 16 (or even the forwarding circuits 17 and 18), for example, to enhance the processing performance of the HEVC apparatus 1. However, the scope of the invention is not limited thereto. Further, each working cycle of the embodiment refers to a time period corresponding to one of the first coding operation and the second coding operation that a single luma frame signal or a single chroma frame signal in each input frame signal undergoes. For example, each working cycle may be a shortest time interval, in which the estimation module 11, the discrete cosine transform module 12, the quantization module 13, the inverse quantization module 14, the inverse discrete cosine module 15 and the pixel reconstruction module 16 are allowed to complete the associated operations on a single luma frame signal (or a single chroma frame signal). Accordingly, based on the number of the input frame signals received, the first coding operation and the second coding operation may correspond to a plurality of working cycles and may be sequentially arranged.

In step 202, the scheduling module 10 generates the control signal according to the plurality of input frame signals received to perform step 204 (i.e., performing the intra-frame coding operation) or step 206 (i.e., performing the inter/intra-frame coding operation). Based on different requirements, one person skilled in the art may separate the determination mechanism corresponding to step 202 into two parts, so as to independently determine whether to perform the intra-frame coding operation and to independently determine whether to perform the inter/intra-frame coding operation. In this case, for example but not limited to, the program code corresponding to step 202 is divided into two sub-program codes for independent operations, or the determination operations of the program codes corresponding to the two are sequentially performed. Operations of step 204 and step 206 may further be concluded into an intra-frame coding process 30 or an inter/intra-frame coding process 60, with associated details given below.

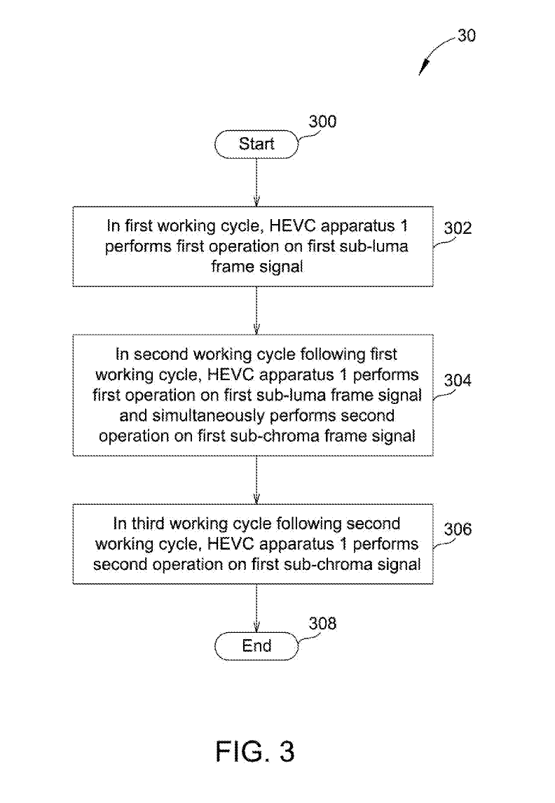

The intra-frame coding process 30 of the embodiment may be compiled into another program code, stored in a storage device of the HEVC apparatus 1, and performed by a processor module of the HEVC apparatus 1 to control associated operations of the work loop module LM. As shown in FIG. 3, the intra-frame coding process 30 includes following steps.

In step 300, the intra-frame coding process 30 begins.

In step 302, in a first working cycle, the HEVC apparatus 1 performs a first operation on a first sub-luma frame signal.

In step 304, in a second working cycle following the first working cycle, the HEVC apparatus 1 performs the first operation on a first sub-chroma frame signal, and at the same time performs a second operation on the first sub-luma frame signal.

In step 306, in a third working cycle following the second working cycle, the HEVC apparatus 1 performs a second operation on the first sub-chroma frame signal.

In step 308, the intra-frame coding process 30 ends.

In this embodiment, the intra-frame coding process 30 performed by the work loop module LM is correspondingly activated according to the control signal and the input frame signals that the work look module LM receives. Further, the scheduling module 10 informs the work look module LM of the corresponding determination results of the luma frame signals or chroma frame signals of the plurality of input frame signals, so as to allow the work loop module LM to sequentially perform the first coding operation on a plurality of sub-luma frame signals of the luma frame signal and a plurality of sub-chroma frame signals of the chroma frame signal.

For example, in this embodiment, assuming that the luma frame signal includes a first sub-luma frame signal and the chroma frame signal includes a first sub-chroma frame signal, the scheduling module 10 sequentially receives the first sub-luma frame signal and the first sub-chroma frame signal. The first operation and the second operation are two successive operations from the pixel estimation operation, the discrete cosine transform operation, the quantization operation, the inverse quantization operation, the inverse discrete cosine transform operation and the pixel reconstruction operation of the coding operation. In this case, in step 302, the work loop module LM of the HEVC apparatus 1 performs the first operation on the first sub-luma frame signal. In step 304, in the second working cycle following the first cycle, the work loop module LM performs the first operation on the first sub-chroma frame signal, and simultaneously performs the second operation on the second sub-luma frame signal. In step 306, in the third working cycle following the second working cycle, the work loop module LM performs the second operation on the second sub-chroma frame signal.

In other words, because a reference relationship of dependency does not exist between the first sub-luma frame signal and the first sub-chroma frame signal, the first coding operation may be performed on at least two signals in a single working cycle in the intra-frame coding process 30 of the embodiment; that is, in step 304, the work loop module LM performs the first operation on the first sub-chroma frame signal and performs the second operation on the first sub-luma frame signal. In this embodiment, the number of the sub-luma frame signals included in each luma frame signal and the number of the sub-chroma frame signals included in each chroma frame signal are illustrative examples, and the number of times of performing step 304 may be correspondingly adjusted according to the number of the sub-luma frame signals and the number of the sub-chroma frame signals. Accordingly, in the intra-frame coding process 30, the coding operation is first performed on one sub-luma frame signal, the first coding operation is performed simultaneously on the sub-luma frame signal and one sub-chroma frame signal in a next working cycle, and the first coding operation is then sequentially performed on the remaining sub-luma frame signals after the first coding operation on the sub-chroma frame signal is completed.

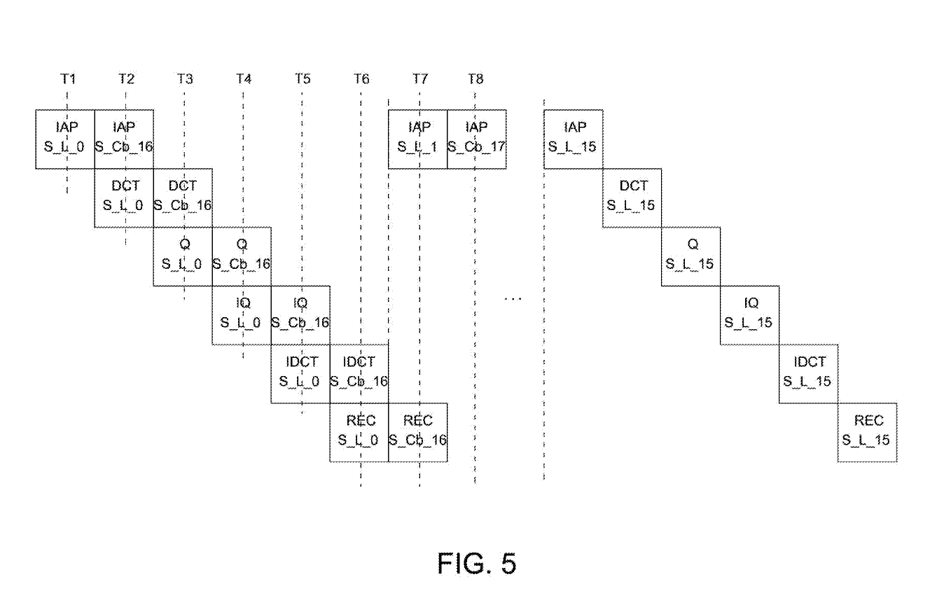

For example, FIG. 4 shows a schematic diagram of a luma frame signal S_L and a plurality of chroma frame signals S_Cb and S_Cr according to an embodiment of the present invention. In this embodiment, the luma frame signal S_L includes a plurality of sub-luma frame signals S_L_0 to S_L_15 (respectively numbered 0 to 15), the chroma frame signal S_Cb includes a plurality of sub-chroma frame signals S_CB_16 to S_Cb_19 (respectively numbered 16 to 19), and the chroma frame signal S_Cr includes a plurality of sub-chroma frame signals SC_r_20 to S_Cr_23 (respectively numbered 20 to 23). FIG. 5 shows a schematic diagram of timings of intra-frame coding operations corresponding to the luma frame signal S_L and the chroma frame signals S_Cb and S_Cr in FIG. 4 according to an embodiment of the present invention. The first coding operation performed on the luma frame signal and the chroma frame signals may be represented as a pixel estimation operation IAP, a discrete cosine transform operation DCT, a quantization operation Q, an inverse quantization operation IQ, an inverse discrete cosine transform operation IDCT and a pixel reconstruction operation REC.

At a first time point T1, the sub-luma frame signal S_L_0 undergoes the pixel estimation operation IAP. At a second time point T2, the sub-luma frame signal S_L_0 undergoes the discrete cosine transform operation DCT, and, at the same time, the sub-chroma frame signal S_Cb_16 undergoes the pixel estimation operation IAP. From a third time point T3 to a sixth time point T6, the sub-luma frame signal S_L_0 undergoes the quantization operation Q, the inverse quantization operation IQ, the inverse discrete cosine transform operation IDCT and the pixel reconstruction operation REC, and, at the same time, the sub-luma frame signal S_L_16 undergoes the discrete cosine transform operation DCT, the quantization operation Q, the inverse quantization operation IQ and the inverse discrete cosine transform operation IDCT. When the sixth time point T6 ends, the sub-luma frame signal S_L_0 has completed the first coding operation, and the corresponding coding result may be buffered in a luma buffer (not shown). Next, the sub-luma frame signal S_L_1 takes its turn to undergo the associated coding operation. That is, at a seventh time point T7, the sub-luma frame signal S_L_1 undergoes the pixel estimation operation IAP, and the sub-chroma frame signal S_Cb_16 undergoes the pixel reconstruction operation REC in a way that its first coding operation is also completed. Similarly, the corresponding result may be buffered in a chroma buffer (not shown). Accordingly, the operation details of every six time points following an eighth time point T8 are a repetition of the operation details from the second time point T2 to the seventh time point T7, so as to simultaneously perform the coding operation on the sub-luma frame signals S_L_1 to S_L_15 and the sub-chroma frame signals S_Cb_17 to S_Cb_19 and S_Cr_20 to S_Cr_23. Only after the sub-chroma frame signal S_Cr_23 has completely undergone the first coding operation, the work loop module LM sequentially completes the first coding operation on the remaining sub-luma frame signals at each of subsequent time points.

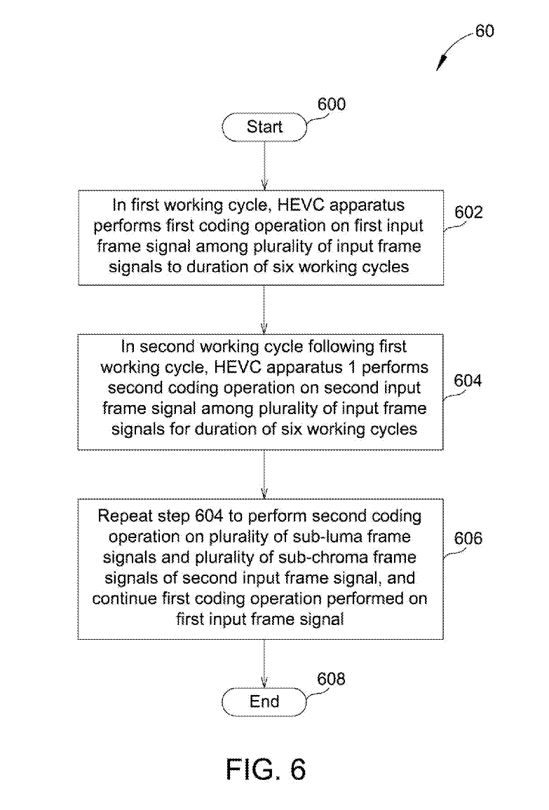

Further, an inter/intra-frame coding process 60 corresponding to the inter/intra-frame coding operation of the embodiment may be compiled into another program code, stored in a storage device of the HEVC apparatus 1, and performed by a processor module of the HEVC apparatus 1 to further control associated operations of the work loop module LM. As shown in FIG. 6, the inter/intra-frame coding operation 60 includes following steps.

In step 600, the inter/intra-frame coding process 60 begins.

In step 602, in a first working cycle, the HEVC apparatus 1 performs a first coding operation on a first input frame signal among a plurality of input frame signals for a duration of six working cycles.

In step 604, in a second working cycle following the first working cycle, the HEVC apparatus 1 performs a second coding operation on a second input frame signal among the plurality of input frame signals for a duration of sixth working cycles.

In step 606, step 604 is repeated to perform the second coding operation on a plurality of sub-luma frame signals and a plurality of sub-chroma signals of the second input frame signal, and the first coding operation performed on the first input frame signal is continued.

In step 608, the inter/intra-frame coding process 60 ends.

In this embodiment, the inter/intra-frame coding process 60 performed by the work loop module LM is correspondingly activated according to the control signal and the input frame signals that the work loop module LM receives. In addition, the scheduling module 10 further informs the work loop module 10 of the determination results corresponding to the luma frame signals or chroma frame signals of the plurality of input frame signals, so as to allow the work loop module LM to perform the first coding operation and the second coding operation sequentially on the plurality of frame signals. For example, the scheduling module 10 of the embodiment receives at least one first input frame signal and one second input frame signal, each of the input frame signal and the second frame signal includes a plurality of luma frame signals and a plurality of chroma frame signals, and the scheduling module 10 sequentially receives the first input frame signal and the second input frame signal. In this case, in step 602, in the first working cycle, the work loop module LM of the HEVC apparatus 1 performs the first coding operation on the first input frame signal for a duration of six working cycles. In step 604, in the second working cycle following the first working cycle, the work loop module LM performs the second coding operation on the second input frame signal for a duration of sixth working cycles. In step 606, the associated operation in step 604 is repeated to perform the second coding operation on the plurality of sub-luma frame signals and the plurality of sub-chroma frame signals of the second input frame signal, and the first coding operation performed on the first input frame signal is continued.

In other words, because a reference relationship of dependency does not exist between the first input frame signal and the second input frame signal, the inter/intra-frame coding process 60 of the embodiment is able to perform the first coding operation and the second coding operation on at least two input frame signals in a single working cycle. That is, the operation performed by the inter/intra-frame coding process 60 may be comprehended as, before the second coding operation performed on the plurality of sub-luma frame signals and the plurality of sub-chroma frame signals of the second input frame signal, in each of the working cycles, the work loop module LM simultaneously performs the first coding operation on the first input frame signal and the second coding operation on the second input frame signal. Once the second coding operation performed on the plurality of sub-luma frame signals and the plurality of sub-chroma frame signals of the second input frame signal is completed, in each of the following working cycles, the work loop module LM only performs the first coding operation on the first input frame signal. Accordingly, in the embodiment, the inter/intra-frame coding process 60 first performs the first coding operation on the first input frame signal in the first working cycle. In the next working cycle, in addition to continuing the first coding process on the first input frame signal, the inter/intra-frame coding process 60 simultaneously performs the second coding operation on the second input frame signal for a duration of multiple working cycles. After the first coding operation of the first input frame signal is completed, the inter/intra-frame coding process 60 may be terminated. It should be noted that, the number of times for performing step 606 may be adjusted according to the number of the sub-luma frame signals and the number of sub-chroma frame signals included in a plurality of input frame signals, and are not to be construed as a limitation to the present invention.

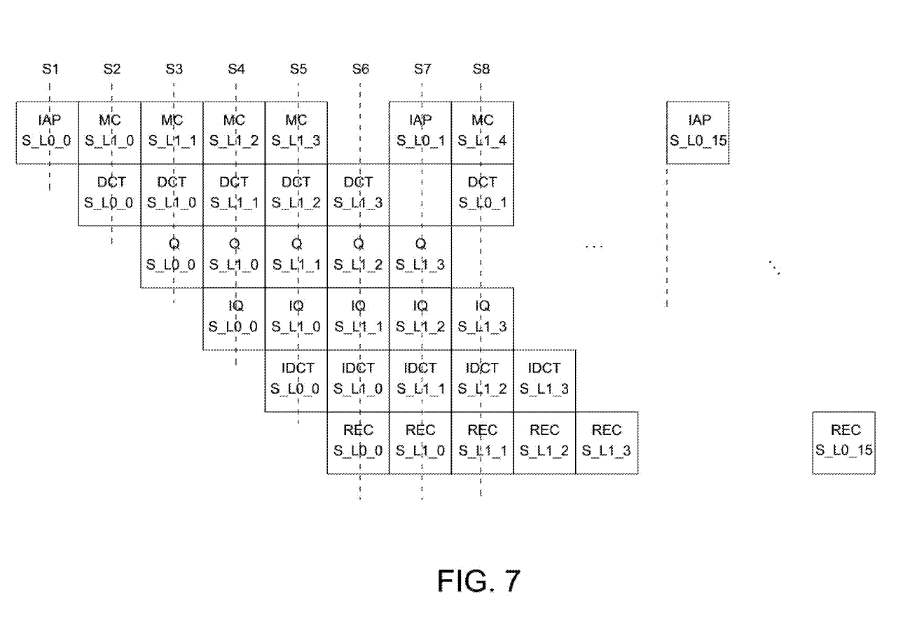

FIG. 7 shows a schematic diagram of timings of inter/intra-frame coding operations correspondingly performed on the luma frame signals S_L0 and S_L1 of a plurality of input frame signals according to an embodiment of the present invention. In this embodiment, only the luma frame signals S_L0 and S_L1 received by the work loop module LM are depicted. The luma frame signals S_L0 and S_L1 respectively include a plurality of sub-luma frame signals S_L0_0 to S_L0_15 and S_L1_0 to S_L1_15 (respectively numbered 0 to 15). The work loop module LM of the embodiment may also simultaneously receive a plurality of chroma frame signals of a plurality of input frame signals. For brevity, for example but not limited to, the sub-luma frame signals are used to represent the existing plurality of input frame signals. In this embodiment, from a first time point S1 to a sixth time point S6, the sub-luma frame signal S_L0_0 undergoes a first coding operation (i.e., sequentially the pixel estimation IAP, the discrete cosine transform operation DCT, the quantization operation Q, the inverse quantization operation IQ, the inverse discrete cosine transform IDCT and the pixel reconstruction operation REC). Further, from a second time point S2 to a seventh time point T7, the sub-luma frame signal S_L1_0 undergoes a second coding operation (i.e., the motion compensation operation MC, the discrete cosine transform operation DCT, the quantization operation Q, the inverse quantization operation IQ, the inverse discrete cosine transform operation IDCT and the pixel reconstruction operation REC). Similarly, from a third time point S3 to a fifth time point S5, the sub-luma frame signals S_L1_1 to S_L1_3 sequentially undergo the second coding operation for a duration of sixth time points. At the sixth time point S6, the sub-luma frame signal S_L_0 has completely undergone the coding operation; at a seventh time point, the sub-luma frame signal S_L0_1 continues to undergo the first coding operation. After the luma frame signal S_L1 has undergone the second coding operation, the work loop module LM continues performing the first coding operation on the luma frame signal S_L0, and ends the associated operations of the inter/intra-frame coding process 60 only after the first coding operation performed on the luma frame signal S_L0 is completed. In an alternative embodiment, operating time points of a plurality of chroma frame signals of different input frame signals may be adaptively added after the operating time points of the luma frame signals S_L0 and S_L1, or the operating time points of these chroma frame signals may be correspondingly arranged on waiting time points for hardware resources of the work loop module LM according to different requirements. The above variations are to be encompassed within the scope of the present invention.

Compared to the prior art, the intra-frame coding process 30 and the inter/intra-frame coding process 60 of the embodiment are capable of controlling a plurality of component modules of the work look module LM to simultaneously perform the first/second coding operation on sub-luma frame signals or sub-chroma frame signals of different input frame signals, hence thoroughly utilizing the waiting time that multiple component modules of the work look module LM originally waste in the prior art, and significantly enhancing the performance of the HEVC apparatus 1. Further, in the embodiment, operations of the forwarding circuits 17 and 18, the intra-frame luma buffer and the inter-chroma buffer are added, which remarkably increase the application scope of the HEVC apparatus 1.

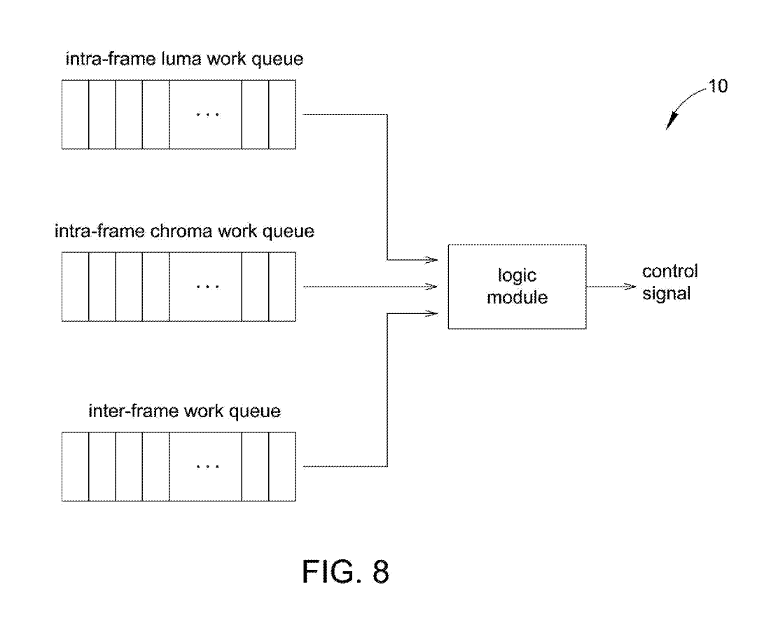

It should be noted that, in the present invention, the scheduling of coding operations of input frame signals is adjusted to correspondingly enhance the processing efficiency. In addition to the variations disclosed in the embodiments, one person skilled in the art may make appropriately modifications based on the foregoing embodiments. For example, FIG. 8 shows a schematic diagram of a scheduling module 10 according to an embodiment of the present invention. As shown in FIG. 8, the scheduling module 10 includes an intra-frame luma work queue, an intra-frame chroma work queue, an inter-frame work queue and a logic module. The logic module determines the dependency among the frame signals, and determines to enable or output contents of the intra-frame luma work queue, the intra-frame chroma work queue or the inter-frame work queue to further output a control signal to the work look module LM. After receiving the control signal from the scheduling module 10, the work loop module LM performs corresponding operations. FIG. 8 illustrates one implementation method of the scheduling module 10, and other variations may be appropriately made thereto according to system requirements.

In conclusion, the embodiments of the present invention teach a scheduling method for an HEVC apparatus. Through the scheduling module and the corresponding parsers, a current input frame signal is determined whether to undergo an intra-frame coding operation or an inter/intra-frame coding operation. Further, the corresponding control signal is transmitted to the estimation module, the discrete cosine transform module, the quantization module, the inverse quantization module, the inverse discrete cosine transform module and the pixel reconstruction module of the work loop module, so as to perform associated coding operations on luma frame signals and chroma frame signals of different input frame signals, thereby reducing the waiting time wasted by hardware resources in the prior art.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scheduling method for a high efficiency video coding (HEVC) apparatus, comprising:
receiving a plurality of input frame signals by a scheduling module of the HEVC apparatus to generate a control signal to determine whether each of the input frame signals is to undergo an inter/intra-frame coding operation, and determining whether each of the input frame signals is a luma frame signal or a chroma frame signal by the scheduling module; and
when the control signal is determined to perform the inter/intra-frame coding operation, performing a first coding operation and a second coding operation sequentially on multiple of the plurality of input frame signals in each working cycle by the HEVC apparatus;
wherein, the first coding operation is sequentially performing a pixel estimation operation, a discrete cosine transform operation, a quantization operation, an inverse quantization operation, an inverse discrete cosine transform operation and a pixel reconstruction operation; the second coding operation is sequentially performing a motion compensation operation, the discrete cosine transform operation, the quantization operation, the inverse quantization operation, the inverse discrete cosine transform operation and the pixel reconstruction operation; each working cycle is a time period corresponding to one of the first coding operation and the second coding operation that a single luma frame signal or a single chroma frame signal in each of the input frame signals undergoes.

2. The scheduling method according to claim 1, further comprising:
when the control signal is determined not to perform the inter/intra-frame coding operation, performing the coding operation sequentially on one of a plurality of sub luma frame signals of each luma frame signal and one of a plurality of chroma frame signals of each chroma frame signal by the HEVC apparatus.

3. The scheduling method according to claim 2, wherein each luma frame signal comprises at least one first sub-luma frame signal, and each chroma frame signal comprises at least one first sub-chroma frame signal; when the control signal is determined not to perform the inter/intra-frame coding operation, the step of performing the first operation on one of the plurality of sub-luma frame signals of each luma frame signal and one of the plurality of sub-chroma frame signals of each chroma frame signal by the HEVC apparatus further comprises:
in a first working cycle, performing a first operation on the first sub-luma frame by the HEVC apparatus;
in a second working cycle following the first working cycle, performing a second operation on the first sub-chroma signal by the HEVC apparatus, and simultaneously performing a second operation on the first sub-luma frame signal by the HEVC apparatus; and
in a third working cycle following the second working cycle, performing the second operation on the first sub-chroma frame signal by the HEVC apparatus;
wherein, the scheduling module sequentially receives the first sub-luma frame signal and the first sub-chroma frame signal, and the first operation and the second operation are two successive operations from the pixel estimation operation, the discrete cosine transform operation, the quantization operation, the inverse quantization operation, the inverse discrete cosine transform operation and the pixel reconstruction operation.

4. The scheduling method according to claim 1, wherein when the scheduling module determines that the inter/intra-frame coding operation is to be performed, the step of performing the first coding operation and the second coding operation sequentially on the multiple of the plurality of input frame signals in each working cycle by the HEVC apparatus further comprises:
in a first working cycle, performing the first coding operation on a first input frame signal among the plurality of input frame signals for a duration of six working cycles by the HEVC apparatus;
in a second working cycle following the first working cycle, performing the second coding operation on a second input frame signal among the plurality of input frame signals for a duration of six working cycles by the HEVC apparatus; and
repeating the above steps to perform the second coding operation on a plurality of sub-luma frame signals and a plurality of sub-chroma frame signals of the second input frame signal, and continuing performing the first coding operation on the first input frame signal.

5. The scheduling method according to claim 4, further comprising:
before completing the second operation performed on the plurality of sub-luma frame signals and the plurality of sub-chroma signals of the second input frame signal, in each working cycle, simultaneously performing the first coding operation on the first input frame signal and the second coding operation on the second input frame signal by the HEVC apparatus.

6. The scheduling method according to claim 4, further comprising:
after the second coding operation performed on the plurality of sub-luma frame signals and the plurality of sub-chroma signals of the second input frame signal is completed, in each following working cycle, performing the first coding operation on the first input frame signal by the HEVC apparatus.

7. The scheduling method according to claim 1, wherein the HEVC apparatus further comprises an estimation module that performs the pixel estimation operation or the motion compensation operation, a discrete cosine transform module that performs the discrete cosine transform operation, a quantization module that performs the quantization module, an inverse quantization module that performs the inverse quantization operation, an inverse discrete cosine transform module that performs the inverse discrete cosine transform operation, and a pixel reconstruction module that performs the pixel reconstruction operation; the estimation module, the discrete cosine transform module, the quantization module, the inverse quantization module, the inverse discrete cosine transform module and the pixel reconstruction module are sequentially coupled to form a work loop module.

8. The scheduling method according to claim 7, wherein each of the estimation module, the discrete cosine transform module, the quantization module, the inverse quantization module, the inverse discrete cosine transform module and the pixel reconstruction module comprises a parser, which receives the control signal of the scheduling module to determine whether to perform the inter/intra-frame coding operation and at the same time determines whether the input signal is the luma frame signal or the chroma luma signal.

9. The scheduling method according to claim 7, wherein the quantization module is further coupled to a forwarding circuit that outputs a residual signal of the quantization module to an intra-frame luma buffer or an intra-frame chroma buffer.

10. The scheduling method according to claim 7, wherein the pixel reconstruction module is further coupled to a forwarding circuit that outputs a reconstruction signal of the pixel reconstruction module to an intra-frame luma buffer or an intra-frame chroma buffer.

11. A high efficiency video coding (HEVC) apparatus, comprising:
a scheduling module, receiving a plurality of input frame signals to generate a control signal to determine whether each of the input frame signals is to undergo an inter/intra-frame coding operation, and determining whether each of the input frame signals is a luma frame signal or a chroma frame signal; and
a work loop module, coupled to the scheduling module, comprising an estimation module, a discrete cosine transform module, a quantization module, an inverse quantization module, an inverse discrete cosine transform module and a pixel reconstruction module that are sequentially coupled;
wherein, when the control signal is determined to perform the inter/intra-frame coding operation, the work loop module performs a first coding operation and a second coding operation sequentially on multiple of the plurality of frame input signal in each working cycle; the first coding operation is sequentially performing a pixel estimation operation, a discrete cosine transform operation, a quantization operation, an inverse quantization operation, an inverse discrete cosine transform operation and a pixel reconstruction operation; the second coding operation is sequentially performing a motion compensation operation, the discrete cosine transform operation, the quantization operation, the inverse quantization operation, the inverse discrete cosine transform operation and the pixel reconstruction operation; and each working cycle is a time period corresponding to one of the first coding operation and the second coding operation that a single luma frame signal or a single chroma frame signal in each of the frame signals undergoes.

12. The HEVC apparatus according to claim 11, wherein each of the estimation module, the discrete cosine transform module, the quantization module, the inverse quantization module, the inverse discrete cosine transform module and the pixel reconstruction module comprises a parser, which receives the control signal of the scheduling module to determine whether to perform the inter/intra-frame coding operation and at the same time determines whether the input signal is the luma frame signal or the chroma luma signal.

13. The HEVC apparatus according to claim 11, wherein the quantization is further coupled to a forwarding circuit that outputs a residual signal of the quantization module to an intra-frame luma buffer or an intra-frame chroma buffer.

14. The HEVC apparatus according to claim 11, wherein the pixel reconstruction module is further coupled to a forwarding circuit that outputs a reconstruction signal of the pixel reconstruction module to an intra-frame luma buffer or an intra-frame chroma buffer.

15. The HEVC apparatus according to claim 11, wherein when the control signal is determined not to perform the inter/intra-frame coding operation, the work loop module performs the first coding operation sequentially on one of a plurality of sub luma frame signals of each luma frame signal and one of a plurality of chroma frame signals of each chroma frame signal.

16. The HEVC apparatus according to claim 15, wherein each luma frame signal comprises at least one first sub-luma frame signal, and each chroma frame signal comprises at least one first sub-chroma frame signal; when the control signal is determined not to perform the inter/intra-frame coding operation, following steps are performed:
in a first working cycle, the work loop module performs a first operation on the first sub-luma frame signal;
in a second working cycle following the first working cycle, the work loop module performs the first operation on the first sub-chroma frame signal, and simultaneously performs a second operation on the first sub-luma frame signal; and
in a third working cycle following the second working cycle, the work loop module performs the second operation on the first sub-chroma frame signal;
wherein, the scheduling module sequentially receives the first sub-luma frame signal and the first sub-chroma signal, and the first operation and the second operation are two successive operations from the pixel estimation operation, the discrete cosine transform operation, the quantization operation, the inverse quantization operation, the inverse discrete cosine transform operation and the pixel reconstruction operation.

17. The HEVC apparatus according to claim 11, wherein when the control signal is determined to perform the inter/intra-frame coding operation, following steps are further performed:
in a first working cycle, the HEVC apparatus performs the first coding operation on a first input frame signal among the plurality of frame input signals for a duration of six working cycles;
in a second working cycle following the first working cycle, the HEVC apparatus performs the second coding operation on a second input frame among the plurality of input frame signals for a duration of six working cycles; and
the above steps are repeated to perform the second coding operation on a plurality of sub-luma frame signals and a plurality of sub-chroma frame signals of the second input frame signal, and the first coding operation performed on the first input frame signal is continued.

18. The HEVC apparatus according to claim 17, wherein when the control signal is determined to perform the inter/intra-frame coding operation, a following step is further performed:
before completing the second operation performed on the plurality of sub-luma frame signals and the plurality of sub-chroma signals of the second input frame signal, in each working cycle, the HEVC apparatus simultaneously performs the first coding operation on the first input frame signal and the second coding operation on the second input frame signal.

19. The HEVC apparatus according to claim 17, wherein when the control signal is determined to perform the inter/intra-frame coding operation, a following step is further performed:
after the second coding operation performed on the plurality of sub-luma frame signals and the plurality of sub-chroma signals of the second input frame signal is completed, in each following working cycle, the HEVC apparatus performs the first coding operation on the first input frame signal.
